(19) United States
(12) Patent Application Publication
(10) Pub. No.: US 2017/0364368 A1
(43) Pub. Date: Dec. 21, 2017

(54) SETTING METHOD OF ACCESSING SYSTEM PARAMETERS AND SERVER USING THE SAME

(71) Applicants: INVENTEC (PUDONG) TECHNOLOGY CORPORATION, Shanghai City (CN); INVENTEC CORPORATION, Taipei City (TW)

(72) Inventor: Jian-Xin HUANG, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/220,239

(22) Filed: Jul. 26, 2016

(30) Foreign Application Priority Data
Jun. 16, 2016 (CN) 201610429850.2

(51) Int. Cl. G06F 9/44; G06F 17/30; H04L 29/08

(52) U.S. Cl. CPC G06F 9/4416; H04L 67/025; G06F 9/4406; G06F 17/3089

(57) ABSTRACT

A setting method of accessing system parameters and a server are provided. The server includes a baseboard management controller. The setting method includes the following steps. First, a remote device is used to log in a webpage of the server according to a network address. Then, a CMOS setting parameter of the server is read out from a storage space of the baseboard management controller and then is loaded in the webpage.

### CROSS-REFERENCE TO RELATED APPLICATIONS

This non-provisional application claims priority under 35 U.S.C. §119(a) on Patent Application No(s). 201610429850.2 filed in China on Jun., 16, 2016, the entire contents of which are hereby incorporated by reference.

### BACKGROUND

### Technical Field

The disclosure relates to a server, more particularly to a setting method of accessing system parameters and a server, and in the method, looking up or editing setting parameters is carried out on a webpage.

### Related Art

Presently, there are two ways to choose if a user intends to look up or edit the settings in a CMOS memory of a computer. One is to promptly press the key F9 or another specific key on the keyboard to enter into the CMOS setting interface when the system boots and enters into the stage of power-on self-test (POST), and then select what to look up or edit via the keyboard. However, the user has to manually restart the computer and press the specific key for entering into the CMOS setting interface if the user intends to look up or edit the CMOS setting by this manner after the system boots. Moreover, it easily occurs for the user to restart the computer again and again because of missing the right time to press the specific key, until the user catches the right time.

The other one is to install a specific application program on the computer. If the user intends to look up or edit the CMOS setting, the user cannot use the installed application program until the computer enters into the operating system (OS) stage. Although this manner allows the user to directly look up or edit the CMOS setting under the OS, such an application program causes extra cost.

Moreover, the above two manners are carried out on the computer, so the user is only allowed to look up or edit the CMOS setting of the computer. If the user cannot use the computer because of the user's location far from the computer, the user cannot look up or edit the CMOS setting of the computer.

### SUMMARY

The disclosure provides a setting method of accessing system parameters and a server using the same, to resolve the above problems in the art.

According to one or more embodiments, a setting method of accessing one or more system parameters is applied to a server including a baseboard management controller (BMC). In an embodiment, the setting method includes the following steps. First, via a remote device, a webpage of the server is logged in according to a network address. Then, a CMOS setting parameter of the server is read from a storage space in the baseboard management controller and is loaded in the webpage.

In another embodiment of the setting method, when the CMOS setting parameter in the webpage is edited, the remote device writes the edited CMOS setting parameter in the storage space to replace a previous version of the CMOS setting parameter in the storage space.

In yet another embodiment of the setting method, the server further includes a memory electrically connected the baseboard management controller, and an initial version of the CMOS setting parameter is stored in the memory when the server boots for the first time.

In yet another embodiment of the setting method, the following steps are further included. Determining whether the CMOS setting parameter in the storage space is the same as the CMOS setting parameter in the memory is made when the server is booting. When the CMOS setting parameter in the storage space is different from the CMOS setting parameter in the memory, the CMOS setting parameter in the storage space replaces the CMOS setting parameter in the memory.

According to an embodiment, a server includes a baseboard management controller. The baseboard management controller includes a storage space for storing a CMOS setting parameter. The baseboard management controller can communicate with a remote device. When the remote device logs in a webpage of the server according to a network address, the baseboard management controller sends the CMOS setting parameter in the storage space to the remote device so that the webpage can load this CMOS setting parameter.

In another embodiment of the server, when the CMOS setting parameter in the webpage is edited, the baseboard management controller stores the edited CMOS setting parameter in the remote device into the storage space to replace a previous version of the CMOS setting parameter in the storage space.

In yet another embodiment of the server, a memory is further included. The memory is electrically connected to the baseboard management controller, and an initial version of the CMOS setting parameter is loaded in the memory when the server boots for the first time.

In yet another embodiment of the server, a processor is further included. The processor is electrically connected to the memory and the baseboard management controller. The processor determines whether the CMOS setting parameter in storage space is the same as the CMOS setting parameter in the memory during the booting of the server. When the CMOS setting parameter in the storage space is different from the CMOS setting parameter in the memory, the processor replaces the CMOS setting parameter in the memory by the CMOS setting parameter in the storage space.

In yet another embodiment of the server, the memory is a non-volatile random access memory.

In yet another embodiment of the server, the storage space is provided by a flash memory built in the baseboard management controller.

In view of the setting method of accessing system parameters and the server, CMOS setting parameters in a memory in the server are baked up onto storage spaces of a baseboard management controller, and the baseboard management controller is capable of communicating with a remote device so that the remote device is capable of link to a webpage of the server and load one or more of the CMOS setting parameters, stored in the storage spaces of the baseboard management controller, into the webpage no matter if the server boots. Through the webpage, the user can directly look up or edit the present parameter settings of the server. Therefore, the user does not need to enter into the CMOS setting interface on the server by pressing a specific key on the keyboard, reboot the server if missing the right time of pressing the specific key, or additionally install a specific application program, and the user is allowed to remotely monitor the server via the remote device.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of the interaction between a server and a remote device in an embodiment of the disclosure; and

FIG. 2 is a flow chart of a setting method of accessing system parameters in an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

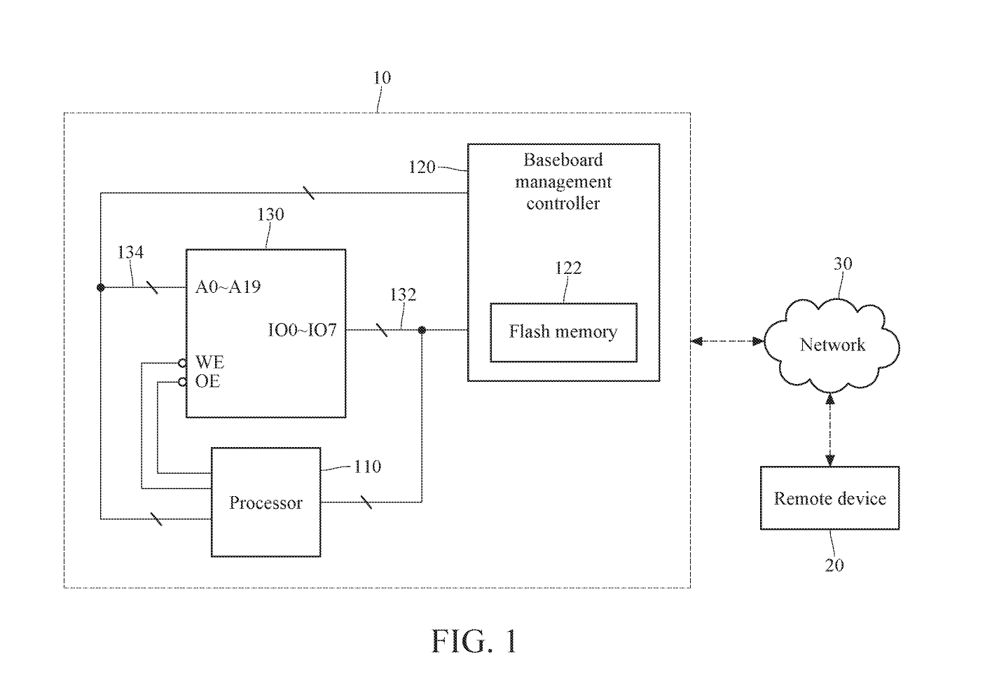

Please refer to FIG. 1, which is a schematic view of the interaction between a server 10 and a remote device 20 in an embodiment of the disclosure. As shown in the figure, both the server 10 and the remote device 20 have a networking function, so in an embodiment, the server 10 can communicate with the remote device 20 via a network 30, such as a wired network or a wireless network. In another embodiment, the server 10 can be directly connected to the remote device 20 via a transmission line. In the disclosure, the communication between the server 10 and the remote device 20 is not limited to a wired communication or wireless communication.

The server 10 at least includes a processor 110, a baseboard management controller 120 and a memory 130, and the processor 110, the baseboard management controller 120 and the memory 130 are electrically connected. Specifically, in an embodiment, a writing control port WE and an output control port OE of the memory 130 are electrically connected to the processor 110; data accessing ports A0˜A19 (generically referred to as storage address end 134 hereinafter) of the memory 130 are electrically connected to the processor 110 and the baseboard management controller 120; and input/output ports IO1˜IO7 (generically referred to as a data end 132 hereinafter) of the memory 130 are electrically connected to the processor 110 and the baseboard management controller 120. The connections among the processor 110, the baseboard management controller 120 and the memory 130 via connection ports as described above are only for an exemplary explanation rather than for limiting the disclosure; and in other words, a person of ordinary skill in the art can design the connections among the processor 110, the baseboard management controller 120 and the memory 130 according to a variety of actual requirements and applications.

The processor 110 is used to handle the operation of the entire server 10. With respect to one of the functions own by a processor, when the server 10 is booting, the processor 110 reads out one or more CMOS setting parameters of the server 10 from the data end 132 of the memory 130 according to an address indicated on the storage address end 134, and operates and gives a control according to the one or more CMOS setting parameters that are read out. Moreover, the processor 110 determines whether CMOS setting parameters are updated, to control the server 10 to operate according to up-to-date CMOS setting parameters. How the processor 110 reads out a CMOS setting parameter of the server 10, whether a CMOS setting parameter is updated, and other relevant operation of the processor 110 will be explained in detail later.

The baseboard management controller 120 is a core to manage the server 10 and is based on an intelligent platform management interface (IPMI). The baseboard management controller 120 uses an independent power source, network interface controller (NIC) and firmware and is programmed to perform a variety of functions, such as the monitoring of detectors, system even logs (SEL), kernel-based virtual machine (KVM)/serial over LAN (SOL)/virtual media, power control, and warning. Note that the disclosure has no limitation to the functions of the baseboard management controller 120, and a person of ordinary skill in the art can design and define the functions of the baseboard management controller 120 according to a variety of practical requirements. In this embodiment, the network interface controller of the baseboard management controller 120 has one or more networking ports, so the baseboard management controller 120 can link to the network 30 via the one or more networking ports. The network interface controller of the baseboard management controller 120 is, for example, not limited to a dedicated network interface controller (Dedicated NIC) or a shared network interface controller (Shared NIC). In this embodiment, the disclosure has no limitation to the types of the network interface controller of the baseboard management controller 120; and in other words, a person of ordinary skill in the art can select a suitable network interface controller according to a variety of requirements and applications in practice. In a practical example, the baseboard management controller 120 can independently operation, so the baseboard management controller 120 still could communicate with the remote device 20 via its network interface controller even if the server 10 has not booted yet or stays at the hibernation state. The inner components and relevant operation of the baseboard management controller 120 will be described later.

The memory 130 provides a plurality of storage spaces, each of the storage spaces corresponds to a storage address, and the storage address is indicated by the storage address end 134 of the memory 130. Therefore, the memory 130 allows an electric component, module or device to access data in a storage space according to the storage address of the storage space. The process that the baseboard management controller 120 accesses the memory 130 is exemplarily described below.

For example, when the baseboard management controller 120 tries writing a piece of data in the memory 130, the baseboard management controller 120 would enable the memory 130 and set the output control port OE at the high voltage potential and the writing control port WE at the low voltage potential, so this data on the data end 132 could be written in a storage space corresponding to a storage address indicated by the storage address end 134. As another example, when the baseboard management controller 120 tries reading a piece of data from the memory 130, the baseboard management controller 120 would enable the memory 130 and set the output control port OE at the low voltage potential and the writing control port WE at the high voltage potential, so the baseboard management controller 120 could read this data from a storage space corresponding to a storage address indicated by the storage address end 134. Likewise, other electric components, modules or devices try access data stored in the memory 130, a manner similar to the foregoing process can be used and thus, is not repeatedly described hereinafter.

Note that the voltage potential of each port of the memory 130 is only for a concise exemplary description rather than for limiting the disclosure when an electric component, module or device accesses data stored in the memory 130. A person of ordinary skill in the art can design and define the voltage potential of each port of the memory 130 according to a variety of practical requirements and applications. Moreover, in an embodiment, the memory 130 is a non-volatile random access memory (NVRAM) or any possible memory, in which data still retains when the power is cut off or interrupted.

In addition, the data in the memory 130 is accessible as long as the memory 130 is enabled, and the memory 130 is able to be enabled as long as the server 10 boots. In the case of a table of CMOS setting parameters (referred to as CMOS setting parameter list hereinafter), if it is required to access or edit the CMOS setting parameter table as the memory 130 has not enabled yet, a manner or device for looking data up in or editing the CMOS setting parameter table is required as the memory 130 has not enabled yet. For this, the baseboard management controller 120 further provides a storage space in an embodiment, and this storage space is provided by a flash memory 122 belonging to or built in the baseboard management controller 120. The disclosure does not limit any possible implementation of the storage space of the baseboard management controller 120 and any possible implementation of accessing data in this storage space, and a person of ordinary skill in the art can design them according to a variety of practical requirements and applications.

In this embodiment, when the server 10 is booting for the first time, the processor 110 could write an initial version of the CMOS setting parameter table in both the storage space of the baseboard management controller 120 and the memory 130 or map an initial version of the CMOS setting parameter table in the memory 130 to the storage space of the baseboard management controller 120. Therefore, when the server 10 boots or reboots, the processor 110 may fast determine whether CMOS setting parameters in the table stored in the storage space of the baseboard management controller 120 are the same as the related CMOS setting parameters in the table stored in the memory 130. When the CMOS setting parameters in the storage space of the baseboard management controller 120 are the same as the related CMOS setting parameters in the memory 130, it indicates that these CMOS setting parameters are not edited. In this situation, the processor 110 can directly read them from the memory 130 for the follow-up operation and control. In contrast, when the CMOS setting parameter table in the storage space of the baseboard management controller 120 is different from its related CMOS setting parameter table in the memory 130, it indicates that the CMOS setting parameter table in either the storage space of the baseboard management controller 120 or the memory 130 has been edited or updated. Therefore, the processor 110 could read one or more CMOS setting parameters in the edited table for the follow-up operation and control.

Moreover, looking up data in or editing the CMOS setting parameter table can be carried out on the server 10 or the remote device 20. The tow manners to look up data in or edit the CMOS setting parameter table are exemplarily described above.

In a situation, when a user tries to directly use the server 10 to look data up in or edit the CMOS setting parameter table, the lookup manner and the editing manner can refer to existing or feature lookup manners and editing manners. For example, the user may press a specific function key on the keyboard to enter into the CMOS setting interface of the BIOS during the booting of the server 10, and then the user may further use the keyboard to look up or edit one or more setting options. As another example, after the server 10 enters into an operating system (OS), the user may use a specific application program installed on the server 10 to look up or edit one or more setting options. However, if a user directly uses the server 10 to edit a CMOS setting parameter, the processor 110 will determine that the version of CMOS setting parameter in the memory 130 is newer than the version of the corresponding CMOS setting parameter in the storage space of the baseboard management controller 120 after the server 10 boots or reboots; and also, the processor 110 will store the newer version of the CMOS setting parameter into the related storage space of the baseboard management controller 120 indicated by the related storage address to replace the older version of the CMOS setting parameter. The manner, by which the newer version of the CMOS setting parameter replaces the older version of the CMOS setting parameter in the storage space of the baseboard management controller 120, can be designed according to a variety of practical requirements.

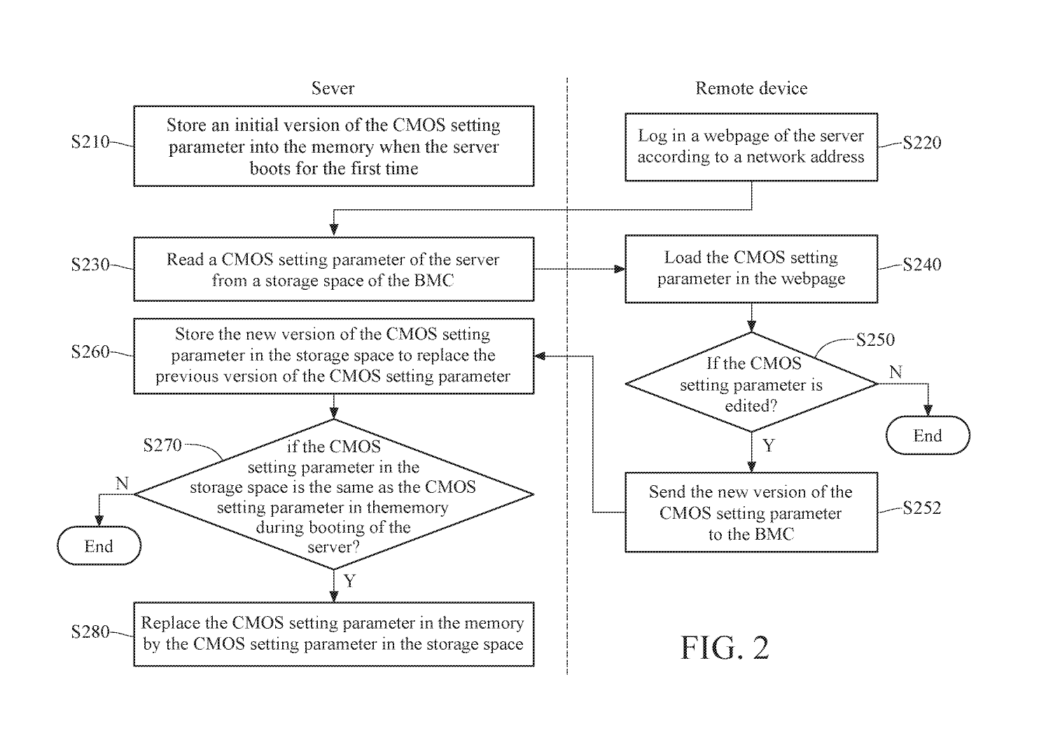

In another situation, when a user tries to use the remote device 20 to look up data in or edit the CMOS setting parameter table, the setting method of accessing system parameters in the disclosure can be applied to look up or edit one or more CMOS setting parameters. Please refer to FIG. 1 and FIG. 2 to illustrate the setting method of accessing system parameters. FIG. 2 is a flow chart of a setting method of accessing system parameters in an embodiment of the disclosure. The setting method includes the following steps.

First, when the server 10 is booting for the first time, an initial version of each of CMOS setting parameters is written in both the memory 130 and the storage space of the baseboard management controller 120, as shown in step S210. The detailed process of writing data into the memory 130 can refer to the foregoing description and thus, will not be described repeatedly. Then, a user could use the remote device 20 to log in a webpage of the server 10 according to a network address of the server 10, as shown in step S220. For example, there is one or more parameter setting fields on the webpage, and one parameter setting field corresponds to a storage address of a storage space of the baseboard management controller 120; and thus, the remote device 20 loads one or more CMOS setting parameters of the server 10 in one or more parameter setting fields in the webpage (as shown in step S240) after reading the one or more CMOS setting parameters from one or more related storage spaces of the baseboard management controller 120 (as shown in step S230). Through the webpage displayed by the remote device 20, the user can remotely check the one or more present parameter settings of the server 10. Also, the remote device 20 detects whether the one or more parameter settings shown in the webpage are edited, as shown in step S250.

When no CMOS setting parameter in the webpage is edited, the remote device 20 continues showing the one or more presently-loaded CMOS setting parameter to the user until the user edits a CMOS setting parameter shown in the webpage or closes the webpage. When the remote device 20 finds that a CMOS setting parameter shown in the webpage is edited, the remote device 20 sends this new version of the CMOS setting parameter to the baseboard management controller 120, as shown in step S252. Then, the baseboard management controller 120 writes this new version of the CMOS setting parameter in the storage space indicated by the storage address corresponding to the CMOS setting parameter, to replace the previous version of the CMOS setting parameter, as shown in step S260.

Subsequently, when the server 10 boots at the next time or reboots, the processor 110 will determine whether each CMOS setting parameter in the respective storage space of the baseboard management controller 120 is the same as its related CMOS setting parameter in the memory 130, as shown in step S270. When each CMOS setting parameter in the related storage space of the baseboard management controller 120 is the same as its related CMOS setting parameter in the memory 130, the processor 110 will determine that each CMOS setting parameter is not edited, so the storage space of the baseboard management controller 120 and the memory 130 will remain their CMOS setting parameters. However, when a CMOS setting parameter in the related storage space of the baseboard management controller 120 is different from its related CMOS setting parameter in the memory 130, the processor 110 will determine that this CMOS setting parameter is edited, so the processor 110 will replace the previous version of the related CMOS setting parameter in the memory 130 by this new version of the CMOS setting parameter in the related storage space of the baseboard management controller 120, as shown in step S280. The manner, by which the new version of the CMOS setting parameter replaces the previous version of the CMOS setting parameter stored in the memory 130, can refer to the description about how data is written into the memory 130, and thus, it will not described hereinafter. Finally, when the server 10 boots at the next time or reboots, the processor 110 will read the updated CMOS setting parameter table from the memory 130 for the follow-up operation and control.

In an embodiment, the steps S220 to S260 could be executed during the booting process of the server 10. In another embodiment, the steps S220 to S260 could be executed after the server 10 boots completely. In yet another embodiment, the steps S220 to S260 could be executed when the server 10 stays at the hibernation state. In yet another embodiment, the steps S220 to S260 could be executed when the server 10 is powered off

In addition, although the above embodiments record one or more CMOS setting parameters in a table, the disclosure does not limit to the data type of recording CMOS setting parameters, and a person of ordinary skill in the art can design the data type of recording CMOS setting parameters according to a variety of practical requirements and applications.

In brief, the disclosure provides a setting method of accessing system parameters and a server using the same, and in the server, a CMOS setting parameter in a memory is backed up onto a storage space of a baseboard management controller. Moreover, the baseboard management controller is able to communicate with a remote device, so no matter the server boots or not, the remote device is able to link to a webpage of the server and load the backup CMOS setting parameter from the storage space of the baseboard management controller into the webpage. Through the webpage, a user is able to directly check and even edit the present parameter setting of the server. Therefore, the user does not need to enter into the CMOS setting interface on the server by pressing a specific key on the keyboard, reboot the server if missing the right time of pressing the specific key, or additionally install a specific application program, and the user is allowed to remotely monitor the server via the remote device.

What is claimed is:

1. A setting method of accessing one or more system parameters, applied to a server that comprises a baseboard management controller, the setting method comprising:
logging in a webpage of the server according to a network address via a remote device; and
reading a CMOS setting parameter of the server from a storage space of the baseboard management controller and then loading the CMOS setting parameter in the webpage.

2. The setting method according to claim 1, wherein when the CMOS setting parameter in the webpage is amended, the remote device writes the amended CMOS setting parameter in the storage space to replace a previous version of the CMOS setting parameter in the storage space.

3. The setting method according to claim 2, wherein the server further comprises a memory electrically connected to the baseboard management controller, and an initial version of the CMOS setting parameter is stored in the memory when the server boots for the first time.

4. The setting method according to claim 3, further comprising:
determining whether the CMOS setting parameter in the storage space is the same as the CMOS setting parameter in the memory during booting of the server; and
replacing the CMOS setting parameter in the memory by the CMOS setting parameter in the storage space when the CMOS setting parameter in the storage space is different from the CMOS setting parameter in the memory.

5. A server comprising:
a baseboard management controller comprising a storage space that is configured to store a CMOS setting parameter, and the baseboard management controller configured to communicate with a remote device,
wherein when a webpage of the server is logged in via the remote device according to a network address, the baseboard management controller sends the CMOS setting parameter in the storage space to the remote device so that the webpage loads the CMOS setting parameter.

6. The server according to claim 5, wherein when the CMOS setting parameter in the webpage is edited, the baseboard management controller stores the edited CMOS setting parameter in the remote device into the storage space to replace a previous version of the CMOS setting parameter.

7. The server according to claim 6, further comprising:
a memory electrically connected to the baseboard management controller and configured to load an initial version of the CMOS setting parameter when the server boots for the first time.

8. The server according to claim 7, further comprising:
a processor electrically connected to the memory and the baseboard management controller and configured to determine whether the CMOS setting parameter in the storage space is the same as the CMOS setting parameter in the memory during booting of the server, and to replace the CMOS setting parameter in the memory by the CMOS setting parameter in the storage space when the CMOS setting parameter in the storage space is different from the CMOS setting parameter in the memory.

9. The server according to claim 7, wherein the memory is a non-volatile random access memory.

10. The server according to claim 5, wherein the storage space is provided by a flash memory built in the baseboard management controller.
